(19) United States
(12) Patent Application Publication
(10) Pub. No.: US 2025/0182641 A1
(43) Pub. Date: Jun. 5, 2025

(54) METHOD AND SYSTEM FOR WORLDWIDE TEMPORAL COORDINATION OF, CARRYING OUT AND PAYING FOR CONTENT-SPECIFIC AND LANGUAGE-SPECIFIC LESSON AND CHAT SERVICES

(71) Applicant: MESUBIS GMBH, Opfikon (CH)

(72) Inventor: Cédric ZIMMERMANN, Opfikon (CH)

(21) Appl. No.: 18/837,565

(22) PCT Filed: Dec. 8, 2022
(86) PCT No.: PCT/EP2022/085004

§ 371 Date: Aug. 9, 2024

(30) Foreign Application Priority Data
Dec. 10, 2021 (CH) CH070701/2021
Jul. 21, 2022 (CH) CH000870/2022

(51) Int. Cl. G09B 5/14; G06Q 10/1093; G06Q 30/04; G06Q 50/20

(52) U.S. Cl. CPC G09B 5/14; G06Q 10/1095; G06Q 30/04; G06Q 50/205

(57) ABSTRACT

The systems and processes described herein enable chat interaction between teachers and one or more students, independent of space and time zone, and include automated time zone and language-specific notification of the scheduled lessons and of the student's participation. Students can select content- and language-specific lessons offered on the chat platform from a large number of subject-specific lessons in different languages. To do so, they enter their desired local attendance time and their identification with name, address, e-mail address and mobile number. Possible time windows for conducting the lessons are determined from the temporal intersection of all feedback and communicated to the students. Students can then book a lesson and receive an invoice, which can be paid directly on the platform using an implemented payment method. After payment, students receive online access with an access code to the lesson.

### CROSS-REFERENCE TO RELATED APPLICATIONS

This application is a national phase filing of, and claims priority to, International Patent Application No. PCT/EP2022/085004, filed in Jun. 15, 2023, and entitled “METHOD AND SYSTEM FOR WORLDWIDE TEMPORAL COORDINATION OF, CARRYING OUT AND PAYING FOR CONTENT-SPECIFIC AND LANGUAGE-SPECIFIC LESSONG AND CHAT SERVICES”, which claims priority to Swiss Non-Provisional Application No. CH070701/2021, filed on Dec. 10, 2021, and entitled “METHOD AND SYSTEM FOR WORLDWIDE TEMPORAL COORDINATION OF, CARRYING OUT AND PAYING FOR CONTENT-SPECIFIC AND LANGUAGE-SPECIFIC LESSONG AND CHAT SERVICES”, and Swiss Non-Provisional Application No. CH000870/2022, filed on Jul. 21, 2022, and entitled “METHOD AND SYSTEM FOR WORLDWIDE TEMPORAL COORDINATION OF. CARRYING OUT AND PAYING FOR CONTENT-SPECIFIC AND LANGUAGE-SPECIFIC LESSONG AND CHAT SERVICES”, the contents of which are all expressly incorporated herein in their entirety and for all purposes.

### BACKGROUND

### Field

The present invention relates to the method and a system for coordinating content- and language-specific lesson and chat offers on the Internet on a chat platform in various respects worldwide, then automatically determining and billing them, whereby direct payment on the same chat platform is also made possible, and the lessons are then offered as online chats.

### SUMMARY

Previous distance learning courses have been designed in such a way that coordination for the implementation of certain lessons proves difficult when a large number of students from different regions or even continents want to take part. In addition to the difficulties due to different time zones, there are also language problems and, ultimately, the content of the lessons offered, so that a student can select exactly the content that he actually needs and not attend lessons that are partly uninteresting and irrelevant to him. Without exception, all of the offers currently available require several tools that the student must use to achieve his goal, i.e. to take a lesson he is looking for, i.e. to book and pay for it, and thus to secure access to the lesson.

He must therefore switch from a chat platform on which the lessons are offered to an external calendar in order to ensure appointment confirmations by email. For billing and payment, he must again switch from the chat platform to another Internet service, i.e. to a separate payment service. He must therefore always switch between different apps, for example between the Microsoft Outlook calendar, Outlook email, Microsoft Teams, payment software, etc. Everything is never offered on an easy-to-use chat platform that is available as a complete solution and covers everything that is necessary to find, book and attend a lesson.

The object of the present invention is therefore to create a method and a system for coordinating content- and language-specific lesson and chat offers on the Internet on a single chat platform in various respects, then automatically determining and billing them, whereby direct payment on the same chat platform is also made possible, and the lessons can then be offered and obtained as online chats.

This object is initially achieved by a method for scheduling, coordinating and scheduling, billing, paying and carrying out lesson and chat offers on an Internet-based chat platform, for a space and time zone independent chat interaction between teachers and one or more students and with automated time zone and language specific notification of the set lessons and the participation by the student(s), characterized in that
a) the students select content- and language-specific lessons offered on the chat platform from a variety of subject-specific lessons in different languages, specifying their desired local attendance time and their identification with name, address, e-mail address and mobile number,
b) the temporal intersection of all feedback is determined as one or more possible time slots for conducting one or more lessons and these time slots are displayed to the students in the chat platform,
c) the students who accept one or more of these time slots for the conduct of the lessons in the chat platform, communicate their consent to this and thus book,
d) for the booked lessons, an invoice is automatically created and sent to the consenting students by the chat platform,
e) the students pay this bill directly via a payment method integrated in the chat platform,
f) the lesson is conducted as an online lesson with chat in these time slots for those students who have paid, or they are granted online access to the lesson on the chat platform by sending them an access code.

Basically, it is about creating a solution that integrates everything needed for the worldwide and content- and language-specific offering, coordination, determination, billing, payment and processing as well as for the success control of a training offer in an all-in-one solution. The chat platform therefore integrates the connection of a calendar, a planning system and an integrated payment system and is therefore an all-in-one solution or complete solution.

Accordingly, the system for carrying out this method is designed according to patent claim 5: System for scheduling, coordinating and scheduling, invoicing, paying and carrying out content- and language-specific lesson and chat offers on an Internet-based platform, for a space and time zone independent video chat interaction between teachers and one or more students and with automated time zone and language specific notification and participation, characterized,
a) that it includes a central computer/server with keyboard, display, microphone and webcam, on which software for an Internet-based chat platform runs, and which can be connected via the Internet to a large number of decentralised computers of the same type in the form of PCs, laptops, iPads or mobile phones, whereby at least the following functions can be carried out by means of the platform,
b) that via this chat platform, students of different languages located around the world can select specific lessons from a variety of subject- and language-specific lessons offered on the platform, specifying a desired local attendance time and the identification of the student,
c) Determination of one or more temporal intersections of all feedback by the platform software for one or more possible time windows for the implementation of the offered lesson and display of these time windows by the chat platform on the displays of the students' computers,
d) Feedback from students on the chat platform with indication of a selected time slot for the effective booking and implementation of the lesson,
e) Automatic billing of each booked lesson through the chat platform software with the consenting students and delivery of the generated invoice and processing of the corresponding payment made on the chat platform,
f) Release of the selected and paid lessons through the chat platform on the displays of the students' computers with the corresponding booked lesson, by enabling online access to the lesson,
g) Conducting the lessons on the chat platform as online lessons with chat function in these time slots, so that visual and audio communication between the teacher and students and between the students via the microphones and webcams of the individual computers is possible.

### BRIEF DESCRIPTION OF THE FIGURES

In the following, the whole process is described using diagrams and images as provided and shown by the facility and chat platform, and the individual steps are explained in order to reveal and make the whole concept understandable and to distinguish its advantages over conventional similar offers.

It shows:

FIG. 1 illustrates a chat platform schematically shown as an intermediary between teacher T and student S;

FIG. 2 illustrates an input mask for the selection of a specific lesson offered by a specific teacher T1 by a student S1, where student S1 is located in South America and teacher T1 is located in Europe;

FIG. 3 illustrates an input mask after a student has booked a specific lesson on the chat platform;

FIG. 4 illustrates an appointment sent to the student Hanspeter, based on the chat window of the teacher who sent this appointment invitation to the students;

FIG. 5 illustrates an input mask for the student Cédric, who can accept or reject a lesson for booking;

FIG. 6 illustrates an input mask for the student Cédric, who is confirmed a booked lesson;

FIG. 7 illustrates a display of a planned test lesson for the student Hanspeter, which has been confirmed by him, which is indicated in the lower part of the figure with a pencil symbol instead of a previous question mark;

FIG. 8 illustrates a teacher's-notification of a planned lesson postponement-;

FIG. 9 illustrates a notification of a-lesson time changed by the teacher to the student Hanspeter or also to the students Oliver and Julie;

FIG. 10 illustrates an automatic change and display in the calendar of the chat platform, because it has not yet been confirmed by the student or marked with a question mark in front of the appointment;

FIG. 11 illustrates Teacher Cedric's invitation to the students to decide whether they want to attend this postponed lesson or not;

FIG. 12 illustrates a confirmation request to student Hanspeter whether he reconfirms the lesson on Sep. 1, 2021;

FIG. 13 illustrates a confirmation to teacher Cédric whether the student confirms or rejects the changes and rebooking;

FIG. 14 illustrates a confirmation of the changes by the teacher Cédric;

FIG. 15 illustrates an automatic adjustment of the confirmed new booking in the integrated calendar, for Wednesday, Sep. 1, 2021;

FIG. 16 illustrates a confirmation of completion of a lesson from Sep. 1, 2021; 1130-1245, and the automatic payment of the fee due to the teacher by the platform operator;

FIG. 17 illustrates a situation when a teacher invites different students on different continents to a group lesson.

### DETAILED DESCRIPTION

The basic idea behind the present method and its implementation system is to offer a programmed lesson planning solution that covers several aspects in an integrated way that has never been the case before. The method now combines a chat function with a calendar function, which greatly simplifies scheduling. In addition, there is the integration/automation of the issuing of invoices and the processing of payments for lessons automatically billed by the system. This method is described and explained using the figures, which document masks in the course of processing the method.

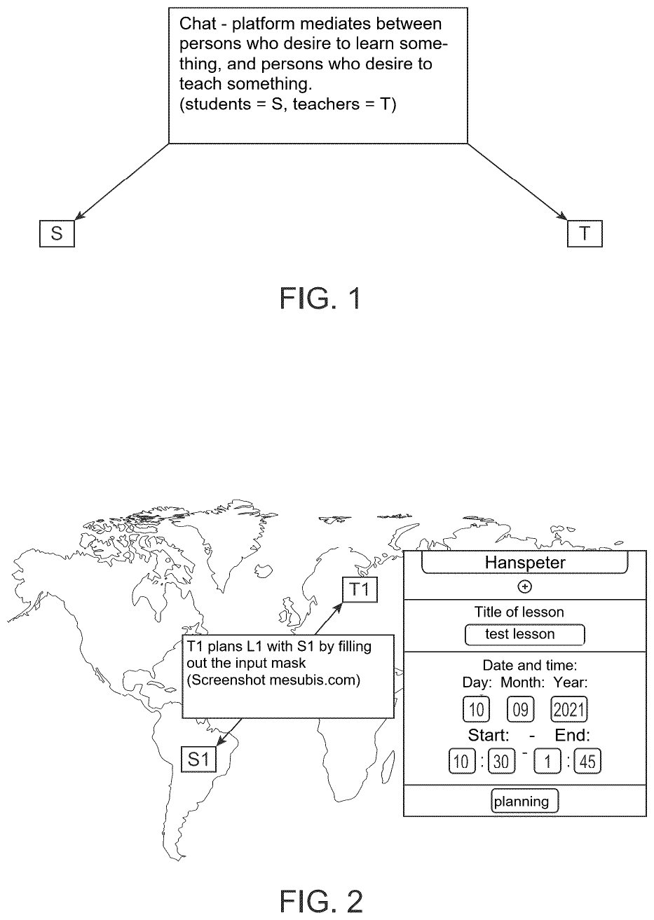

The illustration in FIG. 1 shows schematically that the chat platform with which the present method is operated mediates between a teacher T on the one hand and one or more students S on the other. The method is based on the assumption that a student S would like to plan a lesson Li with a teacher T. The people S and T may be in different countries. If the input mask is sent completely filled out, the corresponding appointment booking is automatically entered in the calendar of the teacher T's platform as “pending”, and a corresponding appointment invitation from the teacher T is automatically sent to the student within the chat provided by the platform.

FIG. 2 shows the initial input mask of the chat platform. Here, a student S1 named Hanspeter is in Brazil and the teacher T1 is in Europe. In this case, the teacher T1 is planning a lesson L1 with the student S1 (Hanspeter) by filling out the input mask shown on the right. Here, the title of the lesson can be selected and a calendar date with the start and end time of the planned lesson can be entered.

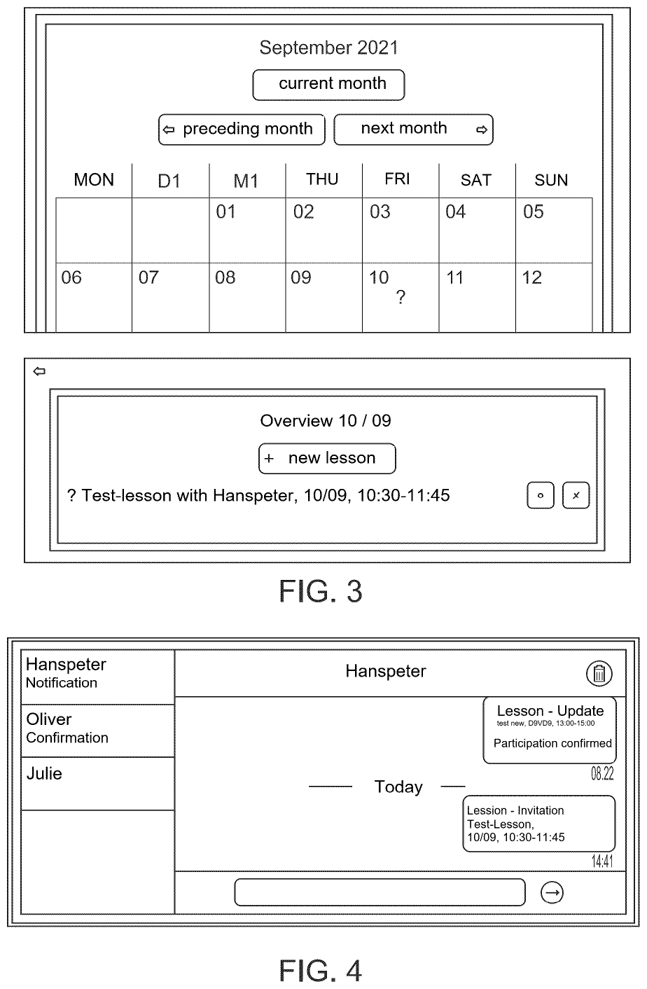

If the input mask is completely filled out and sent via the chat platform, the corresponding appointment booking is automatically entered as pending in the calendar integrated into the platform for teacher T1, as shown in FIG. 3, here for Sep. 10, 2021, 1030-1145, and a corresponding appointment invitation is automatically sent from teacher T1 to student S1 within the chat provided by the platform. This test lesson is still marked with a question mark at the bottom of FIG. 3 because the lesson has not yet been confirmed by the student.

The next figure, FIG. 4, shows the chat as it is displayed for the student Hanspeter after he has confirmed the lesson in question on the platform. Therefore, for the student Hanspeter in his time zone it now says: Test new 09/09 13:00 to 15:00. The teacher is in a time zone of September 10th, while for the student it is still Sep. 9, 2021, i.e. across the date line. In this view, the lesson time is displayed according to the student's time zone.

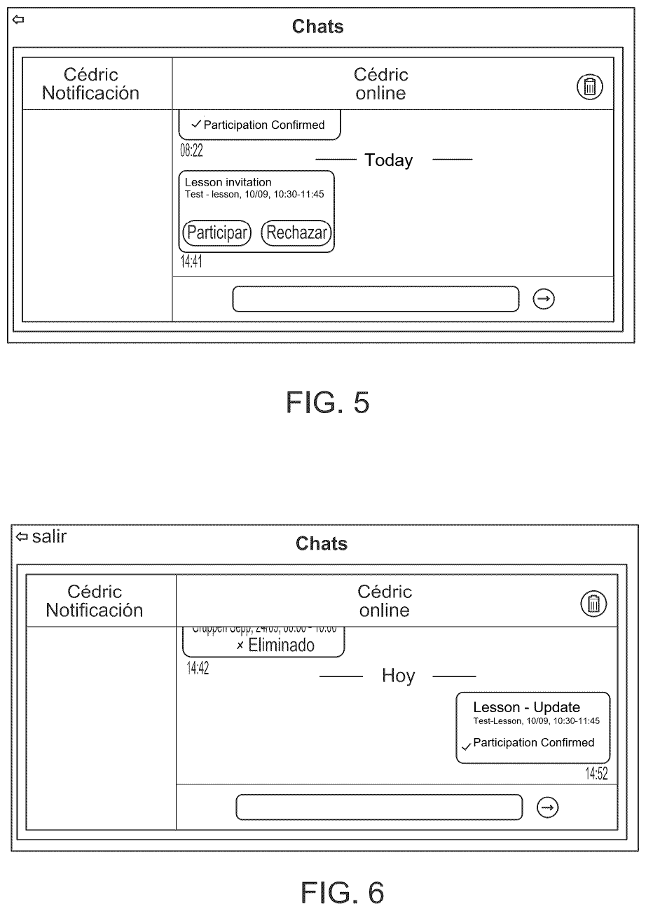

The next image after FIG. 5 shows an invitation from teacher Cédric to student Hanspeter, and the student can book or reject the lesson in Spanish—the local language at his home, i.e. participate (Participar) or decline (Rechazar). If he wants to participate and clicks on Participar, a confirmation message is automatically sent to teacher T1 Cédric, which is again, as always, adjusted to the time zones of student S1 and teacher T1 and displayed accordingly for the student and teacher. The booked lesson is confirmed according to the next image, FIG. 6.

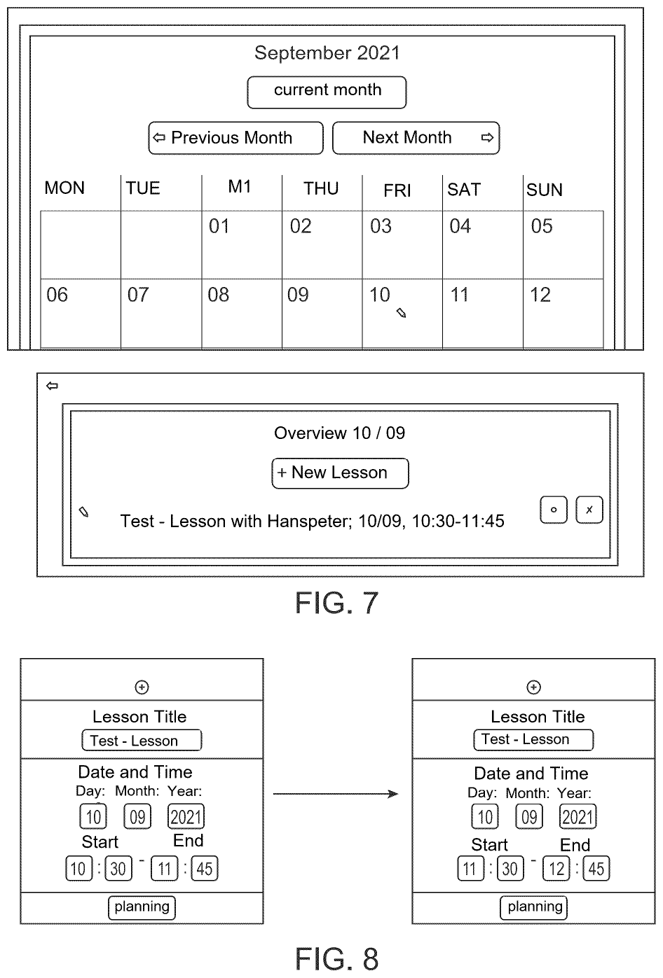

FIG. 7 shows how the lesson is then also transferred to the platform calendar of the teacher and now also the student as a planned lesson. This is illustrated by the fact that there is no longer a question mark icon displayed in front of the specified lesson date, but a pencil icon, as can be seen in the lower image of FIG. 7. The appointment is then sent from the teacher to the student in the chat. In this view according to FIG. 7, the lesson time is displayed according to the student's time zone-here in the lower part of the image Sep. 10, 2021, 10:30 a.m. to 11:45 a.m.

Since this mechanism is the lesson confirmation, this step is coupled with the payment of the lesson fees from Si to Ti (in this example, 1 hour and 5 minutes×hourly cost). In addition to these tools, the platform calendar can be synchronized at any time with the calendar of the hardware of the user concerned in order to always have the corresponding appointments directly available in the calendar. For example, after confirming the lesson, the teacher Ti can click on an “add to calendar” button to add the appointments to his Google calendar on his Android or OS phone, or to any other calendar app.

The principle of this computer-implemented invention is therefore to provide a centralized system which links and automates the entire planning, communication, billing and payment in relation to the booked appointments, in this case in the form of lessons, with the chat of all parties involved.

The concept can be extended to all other booking functions of the platform. In this sense, appropriate notifications and calendar changes are made when planned lessons are cancelled and automatic refunds are made to the virtual accounts on the platform, but also when lessons are updated and/or group lessons are planned or group lesson members are excluded. This always takes into account the respective time zone and effectively booked payments or refunds to the parties involved.

The following pages document an example of a lesson change in lesson L1. This can be triggered using the gear wheel in the previous illustration in FIG. 7. By clicking on this gear wheel function, teacher T1, for example, can return to the lesson input mask and adjust the lesson data.

The next image after FIG. 8 is a view of the student chat showing how the lesson time details are calculated in Si's time zone. In this example, for the student in a time zone 1 hour behind that of the teacher, the lesson time is shifted back by 1 hour, from 10:30 to 11:30 and from 11:45 to 12:45.

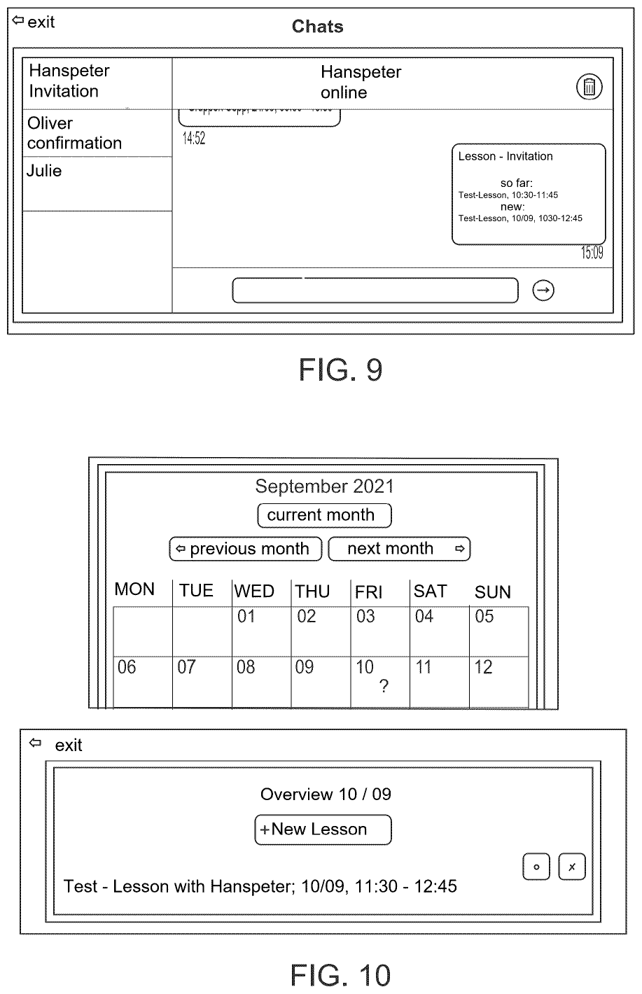

FIG. 9 shows an example of how the teacher's request to the student Hanspeter is displayed when the lesson is to be postponed by one hour, on Sep. 10, 2021 the start from 10:30 to 11:30 and the end of the lesson from 11:45 to 12:45.

FIG. 10 shows how this request appears in the integrated calendar. The requested new appointment is still marked and shown with a question mark.

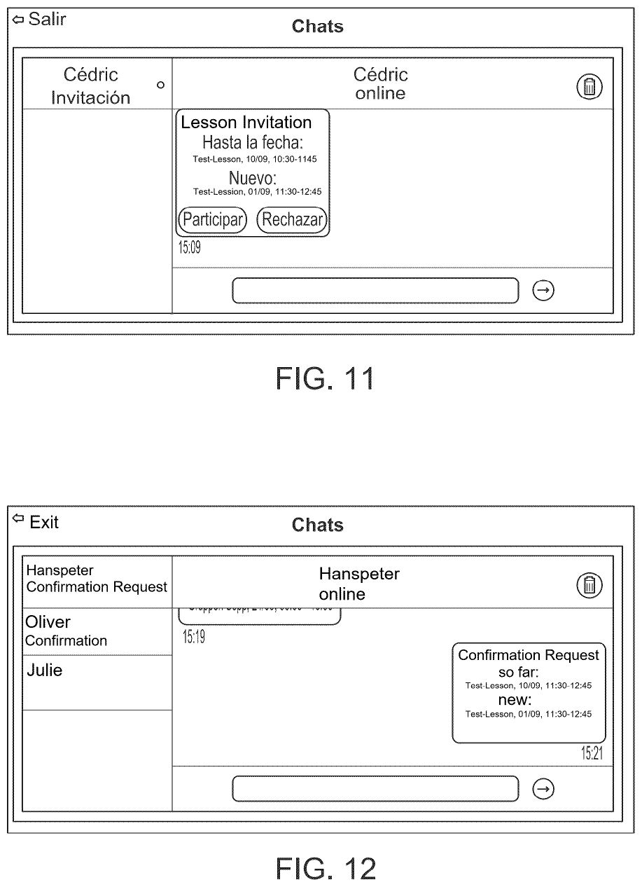

FIG. 11 shows the next mask that goes from the teacher Cédric to the student, and where the student can now accept (participar) or reject (rechazar) this change of date.

Finally, in another example, the student, here Hanspeter, receives a request according to FIG. 12 asking whether he accepts the lesson scheduled for Sep. 1, 2021 instead of Sep. 10, 2021, rescheduled for Sep. 1, 2021, i.e. brought forward by 9 days.

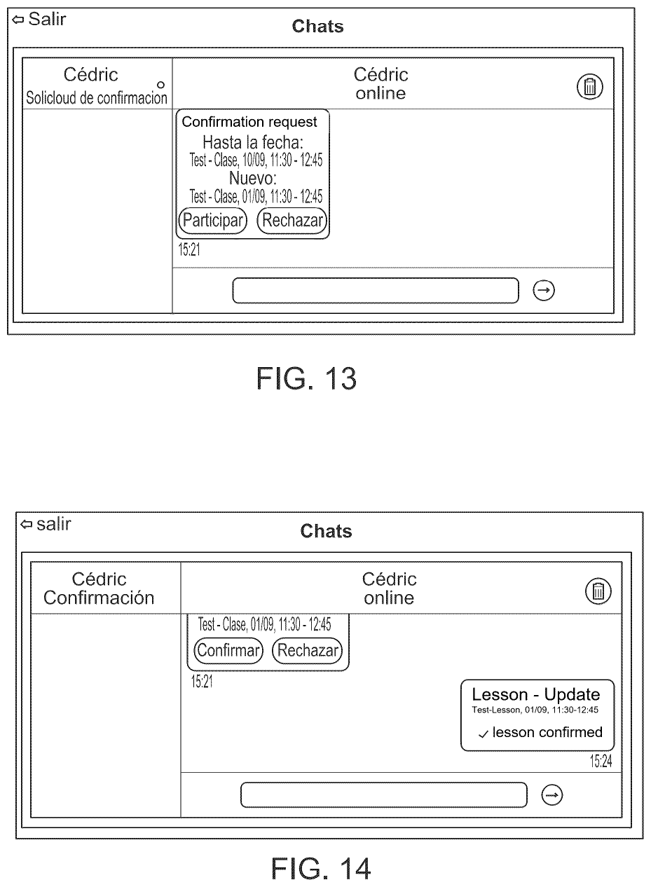

Using the window shown in FIG. 13, he can accept (Participar) or reject (Rechazar) this postponement (Spanish for “Accept” and “Reject”). The language of any such informative messages is also adapted to the language of the respective user, as can be seen here, for example, from the button labels “Participar” and “Rechazar”. If a student Si confirms the lesson by clicking on “Participar”, a confirmation message is automatically sent to the teacher Ti, which, as always, is adapted to the time zones of Si and Ti and displayed accordingly for Si and Ti.

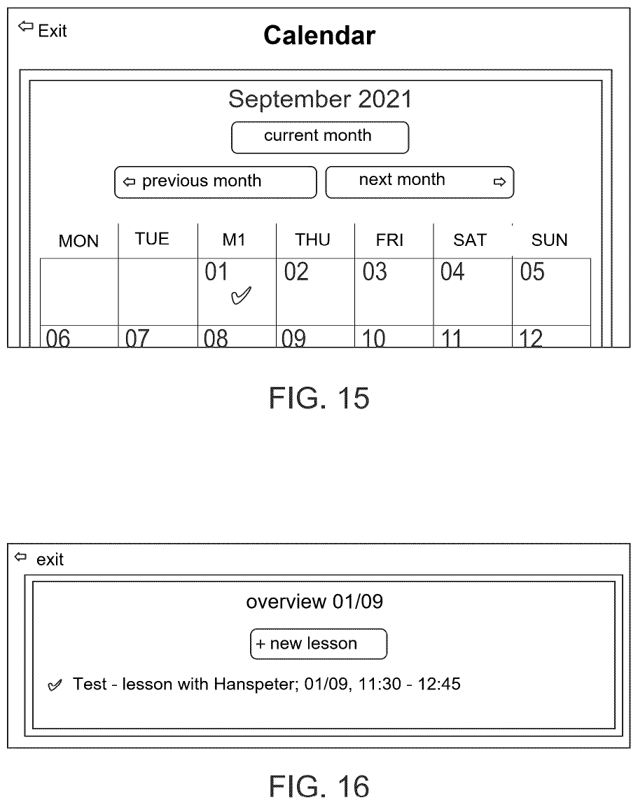

If the student confirms the change, the screen shown in FIG. 14 appears. As FIG. 15 shows, the lesson is now also transferred to the platform calendar of T1 and now also S1 as a “planned lesson” on September 1st. To illustrate this, there is no longer a “?” icon on the display in the lower part of the image, but a pencil icon as shown in FIG. 16. Since this mechanism is the lesson confirmation, this step is linked to the payment of the lesson fees from Si to Ti, in this example 1 hour and 5 minutes×hourly cost.

In addition to these features, the chat platform calendar can be synchronized at any time with the calendar of the hardware of the user concerned in order to always have the corresponding appointments directly available in the calendar. For example, after confirming the lesson, the teacher can click on a button “add to calendar” to add the appointments, for example, to his Google calendar on his Android OS phone.

The principle of this computer-implemented procedure and the necessary system is to provide a centralized system that directly links and automates the entire planning, communication and payment of the booked appointments, here lessons, with the chat of all parties involved.

The procedure is extendable to all other booking functions of the platform. In this sense, appropriate notifications are generated and calendar changes are made in the event of cancellation of scheduled lessons, as well as corresponding refunds to the virtual accounts in the platform, but also in the event of updates to lessons and/or the planning of group lessons/exclusion of group lesson members. All this is always done taking into account the respective time zone and the payments made as well as any refunds to all parties involved.

Thus, the entire procedure and the process behind it, from requesting a lesson to paying for the lesson and paying out to the teacher, is automated, integrated into the chat and directly linked to the chat platform calendar. The platform calendar can be synchronized at any time with other specific calendars such as Google Calendar, Apple Calendar, etc. The following examples explain how to plan group lessons; without reproducing the respective screenshots, but according to exactly the same principle.

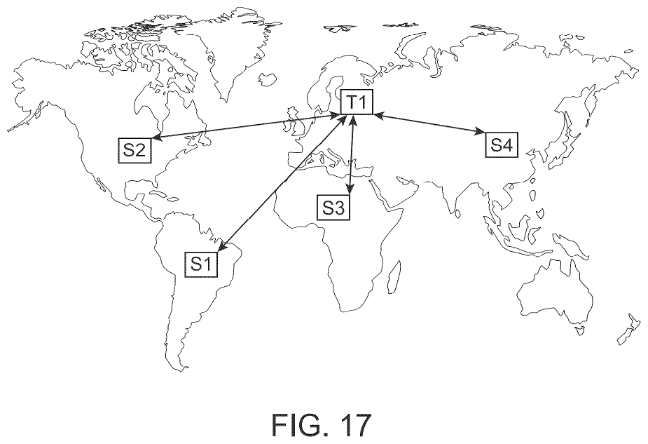

For example, the teacher T1—as illustrated in FIG. 17—plans a group lesson with the students S1, S2, S3 and S4, who are located in different parts of the world, via the input mask. When the input mask is sent, a corresponding lesson invitation is automatically sent from T1 to S1, S2, S3 and S4, who each receive this message with the time and date information converted into their own time zone.

Now several things can happen:
If a student S2 confirms the group lesson, the teacher T1 receives a confirmation message from the corresponding student S2, and S2's payment for the lesson is automatically triggered by a payment software integrated into the chat platform. The same applies to the other group lesson members. The calendar is adjusted for T1 and S2, as well as for all other students who book the group lesson.
If a student S3 cancels his participation in the group lesson, T1 receives an automatic notification of the student S3's withdrawal. Any money already paid by S1, S2 and/or S4 will be credited to S1, S2 and S4 and thus refunded to their account balance. In addition, a new group lesson invitation is automatically sent from T1 to S1, S2 and S4 informing them of S3's withdrawal. The calendar is automatically adjusted for all parties involved.
If teacher T1 cancels the group lesson completely, all students S1, S2, S3 and S4 will be informed of this with a personal message and they will receive a refund of the money they have already paid to their account balance and the calendar will be automatically adjusted for all five parties involved.
Lesson confirmation/deletion occurs for group lessons in the same way as for individual lessons, as mentioned above.

The idea of a second software is that of teaching software which shows a (for example white) window in which you can draw by touch, which results in a black line, for example, and which transmits the drawing to the students in near real-time every xth unit of time, in a kind of lesson chat. Both types of user, i.e. teacher and student, should be able to draw in it. Each participant works with a different color in order to clearly identify the different participants. This should also be available for group lessons. Shapes such as tables etc. should be selectable by clicking.

1. A method comprising:
selecting content- and language-specific lessons offered to students on an Internet-based chat platform from a variety of subject-specific lessons in different languages;
specifying one or more desired local attendance times associated with the students and an identification of each of the students, the identification comprising a name, an address, an e-mail address and a mobile number;
determining a temporal intersection of feedback as one or more possible time windows for implementation of one or more lessons from the content- and language-specific lessons, wherein the one or more possible time windows are displayed to the students in the Internet-based chat platform;
communicating a consent of one or more students who accept at least one time window of the one or more possible time windows for the one or more lessons, to the at least one time window and booking of the one or more lessons;
automatically invoicing, by the Internet-based chat platform, the one or more students for the booked one or more lessons, wherein automatically invoicing the one or more students comprises sending, to the one or more students, one or more invoices for the booked one or more lessons;
paying, by at least one student of the one or more students, via a payment method integrated in the Internet-based chat platform, at least one invoice from the one or more invoices for the booked one or more lessons; and
conducting the booked one or more lessons as an online lesson with chat in the at least one time window for the at least one student who paid the at least one invoice or granting the at least one student online access to the online lesson on the Internet-based chat platform by sending an access code to the at least one student.

2. The method of claim 1, wherein the booking of the one or more lessons can be changed or deleted by a student before payment is processed.

3. The method of claim 1, wherein an entry of the one or more lessons and the one or more possible time windows is saved in an electronic calendar of each requesting student and the entry is communicated to the requesting student via SMS.

4. The method of claim 1, wherein the booked one or more lessons associated with the one or more students are invoiced to the one or more students by automatically generating a cost invoice with a payment deadline and automatically sending the cost invoice to the one or more students via e-mail and notifying the one or more students of the cost invoice being issued via SMS so that the one or more students can subsequently process payment on the Internet-based chat platform.

5. A system comprising:
a central computer with a keyboard, display, microphone and webcam, on which software for an Internet-based chat platform runs, the central computer being connected via the Internet to a number of decentralized computers comprising personal computers (PCs), laptops, tablet computers or mobile phones, wherein the Internet-based chat platform is configured to:
receive, via the Internet-based chat platform, from students of different languages located around the world, selections of specific lessons from a variety of subject- and language-specific lessons offered on the Internet-based chat platform and a desired local attendance time and an identification of each of the students;
determine one or more temporal intersections of all feedback for one or more possible time windows for implementation of the specific lessons and display the one or more possible time windows by the Internet-based chat platform on a display of the personal computers associated with the students;
obtain feedback from the students on the Internet-based chat platform with indication of a selected time slot for booking and implementation of a lesson from the specific lessons;
automatically bill each booked lesson through the Internet-based chat platform to each consenting student from the students and deliver a generated invoice and process a corresponding payment made on the Internet-based chat platform;
release selected and paid lessons through the Internet-based chat platform on the display of one or more personal computers associated with one or more of the students associated with the booked lesson, by enabling online access to the booked lesson; and
conduct the lessons booked lesson on the Internet-based chat platform as an online lesson with chat function in the selected time slot, so that visual and audio communication between a teacher and students and between the students is possible via microphones and webcams of the personal computers.
